(19) United States
(12) Patent Application Publication
(10) Pub. No.: US 2025/0279078 A1
(43) Pub. Date: Sep. 4, 2025

(54) DISPLAY DEVICE

(71) Applicant: CARUX TECHNOLOGY PTE. LTD., SINGAPORE (SG)

(72) Inventors: Yi-Cheng Chang, Tainan (TW); Li-Ho Shen, Tainan (TW)

(73) Assignee: CARUX TECHNOLOGY PTE. LTD., SINGAPORE (SG)

(21) Appl. No.: 19/044,509

(22) Filed: Feb. 3, 2025

(30) Foreign Application Priority Data
Mar. 4, 2024 (CN) 202410244194.3

(51) Int. Cl. G09G 3/34

(52) U.S. Cl. CPC G09G 3/3426; G09G 2310/08; G09G 2320/066

(57) ABSTRACT

The disclosure provides a display device. The display device includes a display panel, a backlight module, and a timing controller. The backlight module provides a light to the display panel. The backlight module has a plurality of regions. Each of the plurality of regions includes a plurality of light-emitting elements. The backlight module includes a backlight driver. The backlight driver includes a first controller and a register. The timing controller provides a determination signal to the first controller and provides a driving signal to the register. There are a plurality of update periods in a frame period, and the first controller receives the determination signal to determine each of the plurality of update periods. The register stores the driving signal. During each of the plurality of update periods, the register provides the driving signal to the plurality of light-emitting elements of a corresponding region.

### CROSS-REFERENCE TO RELATED APPLICATION

This application claims the priority benefit of China application serial no. 202410244194.3, filed on Mar. 4, 2024. The entirety of the above-mentioned patent application is hereby incorporated by reference herein and made a part of this specification.

### BACKGROUND

### Technical Field

The disclosure relates to a display device, and in particular, to a display device including a backlight module.

### Description of Related Art

A display device may include a display panel and a backlight module. The backlight module may improve the display contrast of the display device using a multi-zone backlight control (local dimming) technique. The backlight module updates all driving data during a single frame, and then provides light emission results according to the driving data. However, the above update method is quite time-consuming. When the display device displays a high-speed image, the data update speed of the backlight module may not keep up with the display data update speed of the display panel. Therefore, the display contrast of the display device is decreased. Therefore, how to speed up the data update speed of the backlight module is one of the research focuses of those skilled in the art.

### SUMMARY

The disclosure is directed to a display device that may increase the data update speed of a backlight module.

According to an embodiment of the disclosure, a display device includes a display panel, a backlight module, and a timing controller. The backlight module provides a light to the display panel. The backlight module has a plurality of regions. Each of the plurality of regions includes a plurality of light-emitting elements. The backlight module includes a backlight driver. The backlight driver is electrically connected to the plurality of light-emitting elements. The backlight driver includes a first controller and a register. The timing controller is electrically connected to the display panel and the backlight module. The timing controller provides a determination signal to the first controller and provides a driving signal to the register. There are a plurality of update periods in a frame period, and the first controller receives the determination signal to determine each of the plurality of update periods. The register stores the driving signal. During each of the plurality of update periods, the register provides the driving signal to the plurality of light-emitting elements of a corresponding region.

Based on the above, in the backlight module, the register provides the driving signal to the plurality of light-emitting elements of the corresponding region during the plurality of update periods in the frame period. The register does not provide all driving signals of a single frame to the plurality of regions. Therefore, the data update speed of the backlight module of the disclosure may be improved.

### BRIEF DESCRIPTION OF THE DRAWINGS

FIG. 1 is a schematic diagram of a display device shown according to an embodiment of the disclosure.

FIG. 2 is a schematic diagram of an operation shown according to an embodiment of the disclosure.

FIG. 3A to FIG. 3C are respectively schematic diagrams of a backlight module and a timing controller shown according to an embodiment of the disclosure.

FIG. 4 is a signal timing diagram shown according to an embodiment of the disclosure.

FIG. 5 is a signal timing diagram shown according to an embodiment of the disclosure.

FIG. 6 is a schematic diagram of a timing controller shown according to an embodiment of the disclosure.

FIG. 7 is an operation flowchart shown according to FIG. 6.

FIG. 8 is a signal timing diagram shown according to an embodiment of the disclosure.

FIG. 9 is a schematic diagram of a timing controller shown according to an embodiment of the disclosure.

FIG. 10 is a schematic diagram of a backlight driver shown according to an embodiment of the disclosure.

FIG. 11 is an operation flowchart shown according to FIG. 10.

FIG. 12 is a schematic diagram of a backlight driver shown according to an embodiment of the disclosure.

FIG. 13 is a signal timing diagram shown according to an embodiment of the disclosure.

FIG. 14 is an operation flowchart shown according to FIG. 12.

### DESCRIPTION OF THE EMBODIMENTS

The disclosure may be understood by reference to the following detailed description, taken in conjunction with the drawings, as described below. It should be noted that for the object of clarity and ease of understanding for the reader, each drawing of the disclosure illustrates a portion of an electronic device, and certain elements in each drawing may not be drawn to scale. Furthermore, the number and size of each device depicted in the drawings are illustrative and are not intended to limit the scope of the disclosure.

Certain terms are used throughout the description and the following claims to refer to specific elements. As those skilled in the art will appreciate, electronic device manufacturers may refer to elements by different names. This document does not intend to differentiate between elements that have different names rather than different functions. In the following description and in the scope of the claims, the terms “contains,” “includes,” and “having” are used in an open-ended manner and should therefore be interpreted to mean “containing but not limited to . . . ” Accordingly, when the terms “contains,” “includes,” and/or “having” are used in the description of the disclosure, it will be indicated that the corresponding features, regions, steps, operations, and/or elements are present, and there is, but not limited to, the presence of one or a plurality of corresponding features, regions, steps, operations, and/or elements.

It will be understood that when an element is referred to as being “coupled,” “connected to,” or “conducted to” another element, the element may be directly connected to the other element and the electrical connection may be directly established, or there may be an intermediate element between these elements for relay electrical connection (indirect electrical connection). In contrast, when an element is referred to as being “directly coupled,” “directly conductive to,” or “directly connected to” another element, there are no intervening elements present.

Although terms such as first, second, third, etc. may be used to describe different constituent elements, such constituent elements are not limited by these terms. Terms are used to distinguish constituent elements from other constituent elements in the specification. The scope of the claims may not use the same terms, but may use the terms first, second, third, etc. with respect to the claimed order of the elements. Therefore, in the following description, a first constituent element may be a second constituent element within the scope of claims.

An electronic device of the disclosure may include a display device, an antenna device, a sensing device, a light-emitting device, a touch display, a curved display, or a free shape display, but the disclosure is not limited thereto. The electronic device may include a bendable or flexible electronic device. The electronic device may, for example, include liquid crystal, light-emitting diode, quantum dot (QD), fluorescence, phosphor, other suitable display media, or a combination of the above materials, but the disclosure is not limited thereto. The LED may include, for example, an organic LED (OLED), a mini LED, a micro LED, or a quantum dot LED (may include QLED. QDLED), or other suitable materials, or a combination of the above, but the disclosure is not limited thereto. The display device may include, for example, a tiling display device, but the disclosure is not limited thereto. The antenna device may be, for example, a liquid-crystal antenna, but the disclosure is not limited thereto. The antenna device may, for example, include an antenna tiling device, but the disclosure is not limited thereto. It should be noted that the electronic device may be any combination of the above, but the disclosure is not limited thereto. In addition, the shape of the electronic device may be rectangular, circular, polygonal, with curved edges, or other suitable shapes. The electronic device may have a peripheral system such as a drive system, a control system, a light source system, etc. to support a display device, an antenna device, or a tiling device, but the disclosure is not limited thereto. The sensing device may include a camera, an infrared sensor, a fingerprint sensor, etc., but the disclosure is not limited thereto. In some embodiments, the sensing device may also include a flash lamp, an infrared (IR) light source, other sensors, electronic elements, or a combination thereof, but the disclosure is not limited thereto.

It should be noted that technical features in different embodiments described below may be replaced, recombined, or mixed with each other to constitute another embodiment without departing from the spirit of the disclosure.

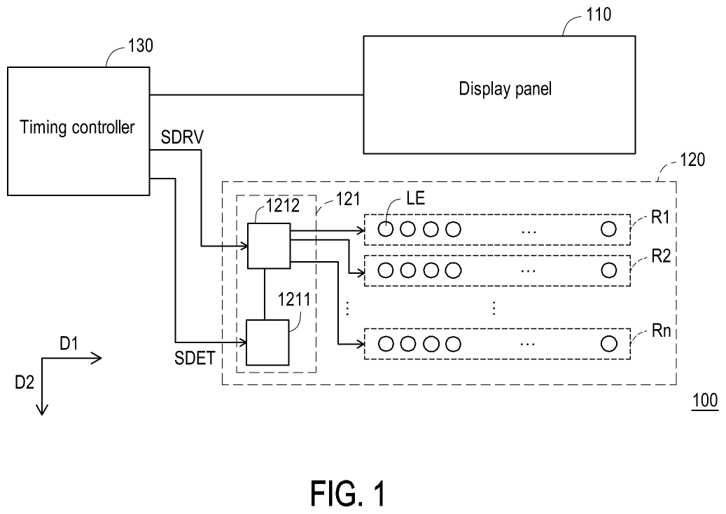

Please refer to FIG. 1. FIG. 1 is a schematic diagram of a display device shown according to an embodiment of the disclosure. In the present embodiment, a display device 100 includes a display panel 110, a backlight module 120, and a timing controller 130. The backlight module 120 provides a light to the display panel 110. The backlight module 120 includes regions R1 to Rn and a backlight driver 121. Each of the regions R1 to Rn includes a plurality of light-emitting elements LE. The regions R1 to Rn are different light-emitting regions respectively. The backlight driver 121 is electrically connected to the plurality of light-emitting elements LE. The backlight driver 121 includes a first controller 1211 and a register 1212. The timing controller 130 is electrically connected to the display panel 110 and the backlight module 120. The timing controller 130 provides a determination signal SDET and a driving signal SDRV to the backlight driver 121. Specifically, the timing controller 130 provides the determination signal SDET to the first controller 1211 and provides the driving signal SDRV to the register 1212.

In the present embodiment, there are a plurality of update periods in a frame period. The first controller 1211 receives the determination signal SDET and determines the update time point of each of the plurality of update periods according to at least the determination signal SDET. The register stores the driving signal. During each of the plurality of update periods, the register 1212 provides the driving signal SDRV to the plurality of light-emitting elements LE of a corresponding region.

It should be mentioned here that, the register 1212 provides the driving signal SDRV to the plurality of light-emitting elements LE of the corresponding region during the plurality of update periods in the frame period. The register 1212 does not provide all driving signals of a single frame to the plurality of light-emitting elements LE of the plurality of regions. Therefore, the data update speed of the backlight module 120 may be improved.

In the present embodiment, the plurality of light-emitting elements LE in each of the regions R1 to Rn are arranged along a direction D1, the regions R1 to Rn are arranged along a direction D2, and the direction D1 is perpendicular to the direction D2. However, the disclosure is not limited to the shape and arrangement of the regions R1 to Rn.

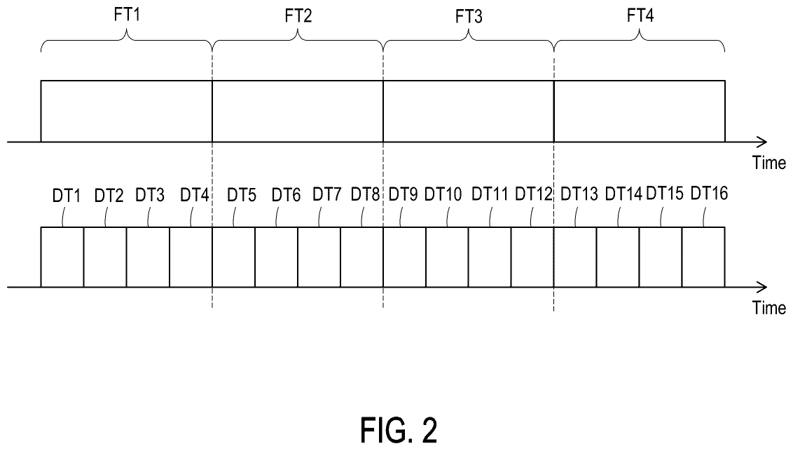

For specific explanation, please refer to FIG. 1 and FIG. 2 simultaneously. FIG. 2 is a schematic diagram of an operation shown according to an embodiment of the disclosure. In the present embodiment, FIG. 2 shows frame periods FT1 to FT4 and update periods DT1 to DT16. Taking the present embodiment as an example, the frame period FT1 includes the update periods DT1 to DT4. The time length of the frame period FT1 is greater than the time length of the update periods DT1 to DT4. The time length of the frame period FT1 may be greater than or equal to 1 millisecond (ms) and less than or equal to 32 ms, and the time length of each of the update periods DT1 to DT4 may be greater than or equal to 1 microsecond (μs) and less than or equal to 16 milliseconds, but the disclosure is not limited thereto. For example, the time length of the frame period FT1 may be any value or any value range such as 1 millisecond, 4 milliseconds, 8 milliseconds, 12 milliseconds, 16 milliseconds, 20 milliseconds, 24 milliseconds, 28 milliseconds, 32 milliseconds, etc. The time length of each of the update periods DT1 to DT4 may be any value or any value range such as 1 microsecond, 100 microseconds, 500 microseconds, 1 millisecond, 2 milliseconds, 4 milliseconds, 8 milliseconds, 12 milliseconds, 16 milliseconds, etc. In some embodiments, the time length of each of the update periods DT1 to DT4 may be the same. In some embodiments, the time length of the frame period FT1 is equal to an integer multiple of the time length of the update period DT1. The present embodiment takes 4 times as an example, but the disclosure is not limited thereto. A frame period FT2 includes the update periods DT5 to DT8. A frame period FT3 includes the update periods DT9 to DT12. The frame period FT4 includes the update periods DT13 to DT16.

Generally, the backlight module of the current display device receives the driving signal of the frame period FT1 and updates all driving signals. When the display panel of the current display device displays a screen during the frame period FT1, the current backlight module receives a driving signal during the frame period FT2 after the frame period FT1, and in the frame period FT3 after the frame period FT2, provides a light emission result corresponding to the screen of the display panel in the frame period FT1. In other words, the current backlight module has an operation delay of at least one frame period (e.g., two frame periods). It should be noted that when the display panel of the current display device displays a white screen (i.e., a high grayscale value screen) during the frame period FT1 and displays a black screen (i.e., a low grayscale value screen) during the frame period FT2, the current backlight module during the frame period FT2 provides a light emission result corresponding to the screen of the display panel during the frame period FT1. Therefore, the display contrast of the current display device is decreased.

In the present embodiment, when the display panel 110 displays a white screen (i.e., a high grayscale value screen) during the frame period FT1 and displays a black screen (i.e., a low grayscale value screen) during the frame period FT2, the backlight module 120 sequentially receives the driving signals of the frame period FT1 during the update periods DT2 to DT5, and sequentially provides light emission results corresponding to the screen of the display panel 110 during the frame period FT1 during the update periods DT3 to DT6. For example, during the update period DT2, the register 1212 receives the driving signal of the drive region R1. During the update period DT3, the register 1212 provides the driving signal of the region R1 to the plurality of light-emitting elements LE. During the update period DT3, the register 1212 receives the driving signal of the drive region R2. During the update period DT4, the register 1212 provides the driving signal of the region R2 to the plurality of light-emitting elements LE, and so on. In other words, the operation delay time of the backlight module 120 is reduced. It should be understood that when the time length of the update period is shorter, the operation delay of the backlight module 120 is also shorter.

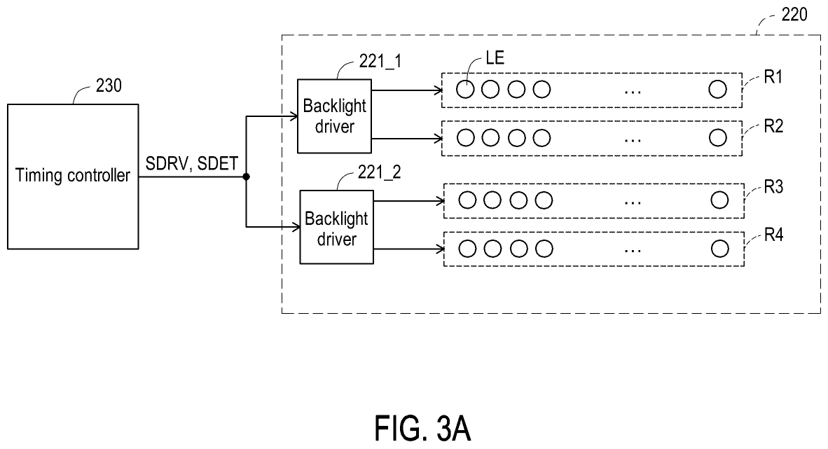

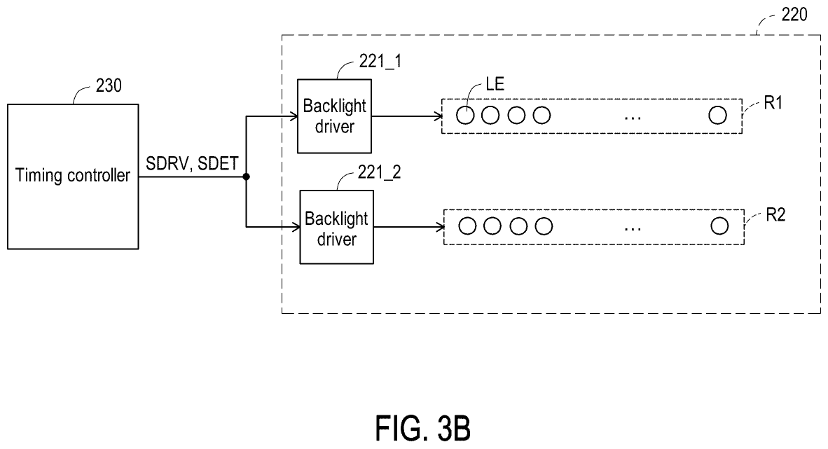

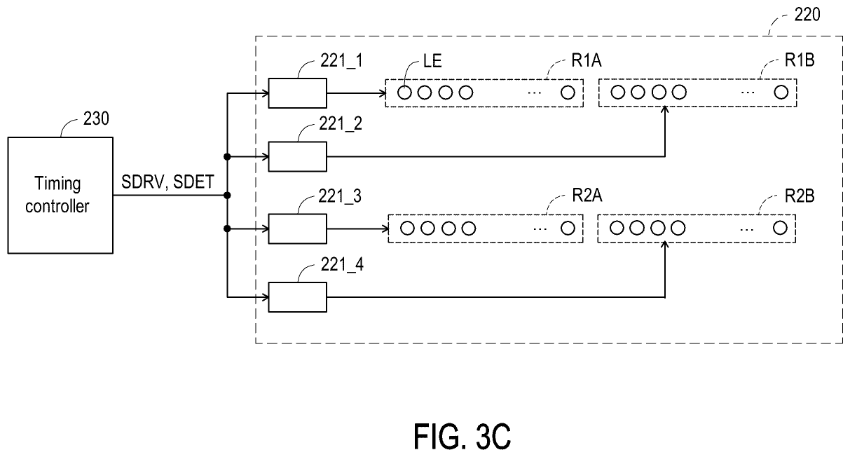

FIG. 3A to FIG. 3C are respectively schematic diagrams of a backlight module and a timing controller shown according to an embodiment of the disclosure. In FIG. 3A, a backlight module 220 includes the regions R1 to R4 and backlight drivers 221_1 and 221_2. The timing controller 230 provides the determination signal SDET and the driving signal SDRV to the backlight drivers 221_1 and 221_2. For example, the timing controller 230 may provide the determination signal SDET and the driving signal SDRV to the backlight drivers 221_1 and 221_2 via a serial peripheral interface (SPI) or other transmission interfaces. The backlight driver 221_1 is used to drive the plurality of light-emitting elements LE of the regions R1 and R2. The backlight driver 221_2 is used to drive the plurality of light-emitting elements LE of the regions R3 and R4.

In FIG. 3B, the backlight module 220 includes the regions R1 and R2 and the backlight drivers 221_1 and 221_2. The timing controller 230 provides the determination signal SDET and the driving signal SDRV to the backlight drivers 221_1 and 221_2. For example, the timing controller 230 may provide the determination signal SDET and the driving signal SDRV to the backlight drivers 221_1 and 221_2 via an SPI or other transmission interfaces. The backlight driver 221_1 is used to drive the plurality of light-emitting elements LE of the region R1. The backlight driver 221_2 is used to drive the plurality of light-emitting elements LE of the region R2.

In FIG. 3C, the backlight module 220 includes regions R1A, R1B, R2A, R2B and backlight drivers 221_1 to 221_4. The regions R1A and R1B are located at the same row. The regions R2A and R2B are located at the same row. The timing controller 230 provides the determination signal SDET and the driving signal SDRV to the backlight drivers 221_1 to 221_4. For example, the timing controller 230 may provide the determination signal SDET and the driving signal SDRV to the backlight drivers 221_1 and 221_2 via an SPI or other transmission interfaces. The backlight driver 221_1 is used to drive the plurality of light-emitting elements LE of the region R1A. The backlight driver 221_2 is used to drive the plurality of light-emitting elements LE of the region R1B. The backlight driver 221_3 is used to drive the plurality of light-emitting elements LE of the region R2A. The backlight driver 221_4 is used to drive the plurality of light-emitting elements LE of the region R2B.

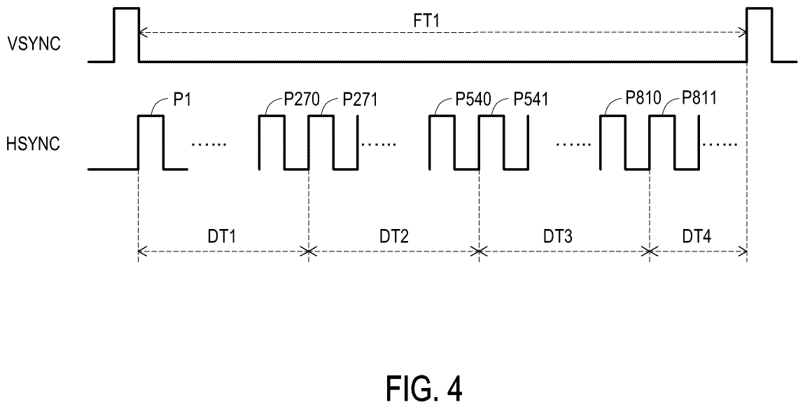

Please refer to FIG. 1 and FIG. 4 simultaneously. FIG. 4 is a signal timing diagram shown according to an embodiment of the disclosure. In the present embodiment, FIG. 4 shows a vertical synchronization signal VSYNC and a horizontal synchronization signal HSYNC used in the display device. The vertical synchronization signal VSYNC may be used to determine the time length of the frame period FT1. For example, the time length of the frame period FT1 is equal to 1080 times of the horizontal synchronization signal HSYNC. The frame period FT1 includes n update periods DT1 to DTn, and the backlight module may be divided into n regions R1 to Rn. For example, “n” is equal to 4. Therefore, the frame period FT1 includes the update periods DT1 to DT4. The update period DT1 corresponds to pulse waves P1 to P270 of the horizontal synchronization signal HSYNC. The update period DT2 corresponds to pulse waves P271 to P540 of the horizontal synchronization signal HSYNC, and so on.

In the present embodiment, during the period of the pulse wave P1, the backlight driver 121 drives the plurality of light-emitting elements LE of the region R3 using the driving signal corresponding to the region R3 of the previous frame period. Therefore, the plurality of light-emitting elements LE of the region R3 provide the light emission result corresponding to the previous frame period. During the period of the pulse waves P2 to P270, the timing controller 130 provides the driving signal corresponding to the region R4 of the previous frame period to the backlight driver 121. During the period of the pulse wave P271, the backlight driver 121 drives the plurality of light-emitting elements LE of the region R4 using the driving signal corresponding to the region R4 of the previous frame period. Therefore, the plurality of light-emitting elements LE of the region R4 provide the light emission result corresponding to the previous frame period.

During the period of the pulse waves P272 to P540, the timing controller 130 provides the driving signal corresponding to the region R1 of the frame period FT1 to the backlight driver 121. During the period of the pulse wave P541, the backlight driver 121 drives the plurality of light-emitting elements LE of the region R1 using the driving signal corresponding to the region R1 of the frame period FT1. Therefore, the plurality of light-emitting elements LE of the region R1 provide the light emission result corresponding to the frame period FT1.

During the period of the pulse waves P542 to P810, the timing controller 130 provides the driving signal corresponding to the region R2 of the frame period FT1 to the backlight driver 121. During the period of the pulse wave P811, the backlight driver 121 drives the plurality of light-emitting elements LE of the region R2 using the driving signal corresponding to the region R2 of the frame period FT1. Therefore, the plurality of light-emitting elements LE of the region R2 provide the light emission result corresponding to the frame period FT1.

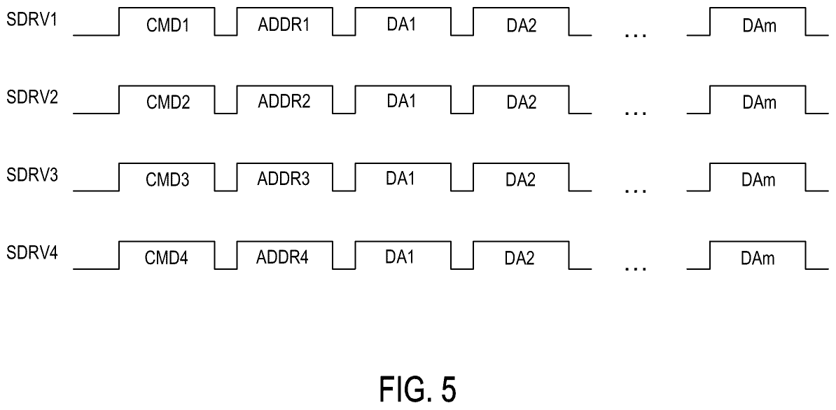

Please refer to FIG. 1, FIG. 4, and FIG. 5 simultaneously. FIG. 5 is a signal timing diagram shown according to an embodiment of the disclosure. FIG. 5 shows a signal timing diagram of the driving signals provided by the timing controller 130. In the present embodiment, during the update period DT2, the timing controller 130 provides a driving signal SDRV1. The driving signal SDRV1 includes a command signal CMD1, an address signal ADDR1, and light emission driving data DA1 to DAm corresponding to the address of the address signal ADDR1. During the update period DT3, the timing controller 130 provides a driving signal SDRV2. The driving signal SDRV2 includes a command signal CMD2, an address signal ADDR2, and light emission driving data DA1 to DAm corresponding to the address of the address signal ADDR2. During the update period DT4, the timing controller 130 provides a driving signal SDRV3. The driving signal SDRV3 includes a command signal CMD3, an address signal ADDR3, and light emission driving data DA1 to DAm corresponding to the address of the address signal ADDR3, and so on.

For example, taking FIG. 4 as an example, during the update period DT2, the backlight driver 121 receives the driving signal SDRV1. The backlight driver 121 drives the plurality of light-emitting elements LE of the region R4 using the driving signal corresponding to the region R4 of the previous frame period according to the command signal CMD1. Next, the backlight driver 121 obtains the light emission driving data DA1 to DAm for driving the plurality of light-emitting elements LE of the region R1 according to the address signal ADDR1. During the update period DT3, the backlight driver 121 receives the driving signal SDRV2. The backlight driver 121 drives the plurality of light-emitting elements LE of the region R1 using the light emission driving data DA1 to DAm according to the command signal CMD2. Next, the backlight driver 121 obtains the light emission driving data DA1 to DAm for driving the plurality of light-emitting elements LE of the region R2 according to the address signal ADDR2.

During the update period DT4, the backlight driver 121 receives the driving signal SDRV3. The backlight driver 121 drives the plurality of light-emitting elements LE of the region R2 using the light emission driving data DA1 to DAm according to the command signal CMD3. Next, the backlight driver 121 obtains the light emission driving data DA1 to DAm for driving the plurality of light-emitting elements LE of the region R3 according to the address signal ADDR3, and so on.

In the disclosure, the signal timing of the driving signal provided by the timing controller 130 is not limited to FIG. 5. For example, the command signals CMD1 to CMD4 may be located after the light emission driving data DA1 to DAm in driving signals SDRV1 to SDRV4 respectively.

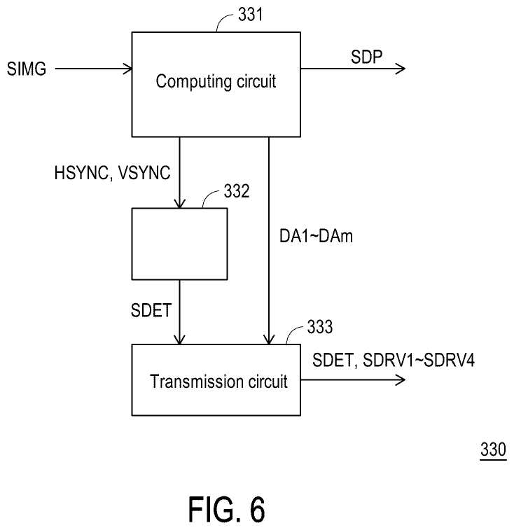

Please refer to FIG. 1, FIG. 5, and FIG. 6 simultaneously. FIG. 6 is a schematic diagram of a timing controller shown according to an embodiment of the disclosure. In the present embodiment, the timing controller 330 includes a computing circuit 331, a second controller 332, and a transmission circuit 333. The computing circuit 331 receives an image signal SIMG and generates a display driving signal SDP and the light emission driving data DA1 to DAm for driving the display panel 110 according to the image signal SIMG. In addition, the computing circuit 331 also provides the horizontal synchronization signal HSYNC and the vertical synchronization signal VSYNC. The second controller 332 is electrically connected to the computing circuit 331. The second controller 332 receives the horizontal synchronization signal HSYNC and the vertical synchronization signal VSYNC and generates the determination signal SDET according to the horizontal synchronization signal HSYNC and the vertical synchronization signal VSYNC. The transmission circuit 333 is electrically connected to the computing circuit 331 and the second controller 332. The transmission circuit 333 receives the determination signal SDET and the light emission driving data DA1 to DAm. The transmission circuit 333 may transmit the determination signal SDET to the backlight driver 121 via an SPI, for example. In addition, the second controller 332 also provides the address signals ADDR1 to ADDR4 and the command signals CMD1 to CMD4 according to the horizontal synchronization signal HSYNC and the vertical synchronization signal VSYNC. The transmission circuit 333 may encode the command signal CMD1, the address signal ADDR1, and the light emission driving data DA1 to DAm corresponding to the address of the address signal ADDR1 into the driving signal SDRV1 and encode the command signal CMD2, the address signal ADDR2, and the light emission driving data DA1 to DAm corresponding to the address of the address signal ADDR2 into the driving signal SDRV2, and so on. The transmission circuit 333 may transmit the driving signals SDRV1 to SDRV4 to the backlight driver 121 via an SPI, for example. Next, the first controller 1211 in the backlight driver 121 determines the update time points of the update periods DT1 to DT4 according to the determination signal SDET generated by the horizontal synchronization signal HSYNC and the vertical synchronization signal VSYNC. The transmission circuit 333 may be implemented by an encoding circuit.

It should be noted that the second controller 332 generates the determination signal SDET according to the horizontal synchronization signal HSYNC and the vertical synchronization signal VSYNC. In this way, the timing controller 330 may determine a plurality of update periods of the backlight module 120.

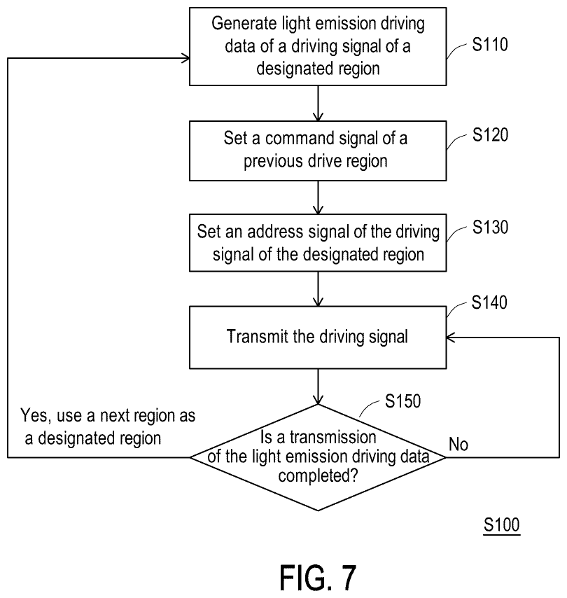

Please refer to FIG. 5, FIG. 6, and FIG. 7 at the same time. FIG. 7 is an operation flowchart shown according to FIG. 6. In the present embodiment, an operation flow S100 includes steps S110 to S150. In step S110, the timing controller 330 generates the light emission driving data DA1 to DAm of the driving signal SDRV1 (i.e., the driving signal corresponding to the designated region) of the region R1. In step S120, the timing controller 330 sets the command signal CMD1 of the drive region R4 (i.e., the previous region). In step S130, the timing controller 330 sets the address signal ADDR1 of the driving signal SDRV1. In step S140, the timing controller 330 transmits the driving signal SDRV1 to the backlight driver 121. In step S150, the timing controller 330 determines whether the transmission of the light emission driving data DA1 to DAm of the driving signal SDRV1 is completed. When the transmission of the light emission driving data DA1 to DAm is not completed, the operation process S100 returns to the operation of step S140. When the transmission of the light emission driving data DA1 to DAm is completed, the region R2 (i.e., the driving signal of the next region) is used as the designated region. The operation process S100 returns to step S110 to set the driving signal SDRV2 and transmit the driving signal SDRV2, and so on.

In addition, the timing controller 230 of FIG. 3A to FIG. 3C may perform the operations of steps S110 to S150.

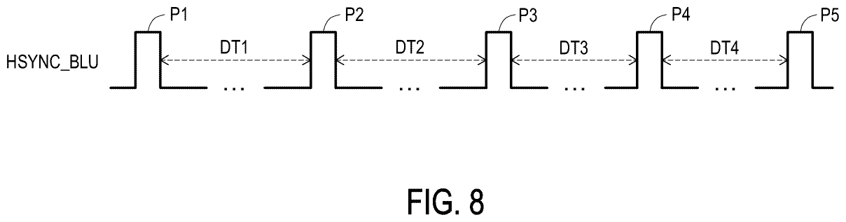

Please refer to FIG. 1 and FIG. 8 simultaneously. FIG. 8 is a signal timing diagram shown according to an embodiment of the disclosure. In the present embodiment, FIG. 8 shows the signal timing of a backlight horizontal synchronization signal HSYNC_BLU. The backlight horizontal synchronization signal HSYNC_BLU may be generated, for example, according to the vertical synchronization signal VSYNC and the horizontal synchronization signal HSYNC. More specifically, the pulse waves P1 to P5 of the backlight horizontal synchronization signal HSYNC_BLU may be generated according to the vertical synchronization signal VSYNC and the counting pulse number of the horizontal synchronization signal HSYNC. The backlight horizontal synchronization signal HSYNC_BLU may be used to determine the time length of the update periods DT1 to DT4. For example, the time interval between the pulse waves P1 and P2 determines the time length of the update period DT1. The pulse waves Pl and P2 may correspond to a plurality of pulse waves (not shown) of the horizontal synchronization signal HSYNC. The time interval between the pulse waves P2 and P3 determines the time length of the update period DT2. The pulse waves P2 and P3 may correspond to a plurality of pulse waves (not shown) of the horizontal synchronization signal HSYNC. The time interval between the pulse waves P3 and P4 determines the time length of the update period DT3. The pulse waves P3 and P4 may correspond to a plurality of pulse waves (not shown) of the horizontal synchronization signal HSYNC. The time interval between the pulse waves P4 and P5 determines the time length of the update period DT4. The pulse waves P4 and P5 may correspond to a plurality of pulse waves (not shown) of the horizontal synchronization signal HSYNC.

In the present embodiment, the operations in the update periods DT1 to DT4 are clearly explained in the embodiments of FIG. 1 and FIG. 4 and are therefore not repeated here.

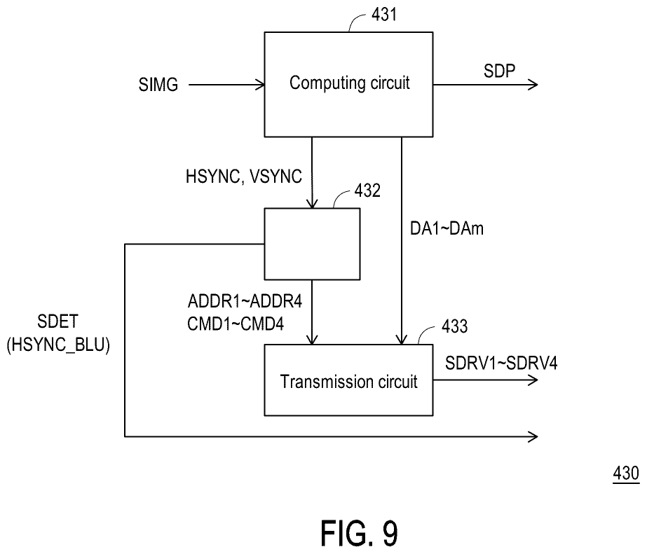

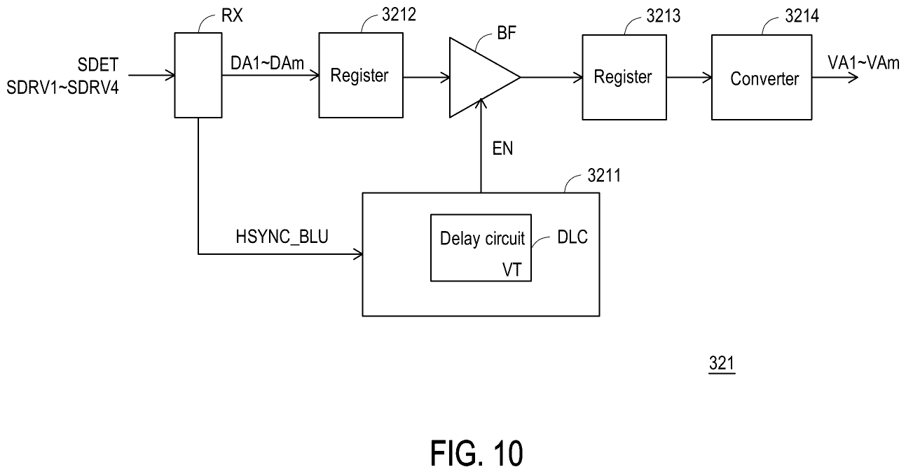

Please refer to FIG. 1, FIG. 8, FIG. 9, and FIG. 10 simultaneously. FIG. 9 is a schematic diagram of a timing controller shown according to an embodiment of the disclosure. FIG. 10 is a schematic diagram of a backlight driver shown according to an embodiment of the disclosure. In the present embodiment, FIG. 9 shows a timing controller 430. FIG. 10 shows a backlight driver 321. The timing controller 430 includes a computing circuit 431, a second controller 432, and a transmission circuit 433. The computing circuit 431 receives the image signal SIMG and generates the display driving signal SDP and the light emission driving data DA1 to DAm for driving the display panel 110 according to the image signal SIMG. In addition, the computing circuit 431 also provides the horizontal synchronization signal HSYNC and the vertical synchronization signal VSYNC. The second controller 432 is electrically connected to the computing circuit 431. The second controller 432 receives the horizontal synchronization signal HSYNC and the vertical synchronization signal VSYNC and provides the address signals ADDR1 to ADDR4, the command signals CMD1 to CMD4, and the determination signal SDET according to the horizontal synchronization signal HSYNC and the vertical synchronization signal VSYNC. The second controller 432 transmits the backlight horizontal synchronization signal HSYNC_BLU to the backlight driver 321. The determination signal SDET includes the backlight horizontal synchronization signal HSYNC_BLU. Therefore, the backlight driver 321 receives the backlight horizontal synchronization signal HSYNC_BLU from the second controller 432. In the present embodiment, the transmission circuit 433 is electrically connected to the computing circuit 431 and the second controller 432. The transmission circuit 433 receives the address signals ADDR1 to ADDR4, the command signals CMD1 to CMD4, and the light emission driving data DA1 to DAm. The transmission circuit 433 may encode the command signal CMD1, the address signal ADDR1, and the light emission driving data DA1 to DAm corresponding to the address of the address signal ADDR1 into the driving signal SDRV1 and encode the command signal CMD2, the address signal ADDR2, and the light emission driving data DA1 to DAm corresponding to the address of the address signal ADDR2 into the driving signal SDRV2, and so on. The transmission circuit 433 may transmit the driving signals SDRV1 to SDRV4 to the backlight driver 321. The transmission circuit 433 may be implemented by an encoding circuit.

In the present embodiment, the backlight driver 321 includes a receiving interface RX, a first controller 3211, registers 3212 and 3213, a buffer BF, and a converter 3214. The receiving interface RX receives the determination signal SDET and the driving signals SDRV1 to SDRV4. The receiving interface RX provides the determination signal SDET (the backlight horizontal synchronization signal HSYNC_BLU) to the first controller 3211, and provides the light emission driving data DA1 to DAm to the register 3212. The first controller 3211 determines the update time points of the update periods DT1 to DT4 according to the backlight horizontal synchronization signal HSYNC_BLU.

The input terminal of the buffer BF is electrically connected to the register 3212. The output terminal of the buffer BF is electrically connected to the converter 3214. Furthermore, the output terminal of the buffer BF is electrically connected to the converter 3214 via the register 3213. The control terminal of the buffer BF is electrically connected to the first controller 3211.

It should be noted that the display panel 110 is, for example, a liquid-crystal display panel. The display panel 110 has the display delay of the liquid-crystal element. Therefore, based on the partition data updates of the plurality of update periods of the backlight module 120, the light output screen of the backlight module 120 may be faster than the display screen of the display panel 110. Therefore, the update time point may need to be delayed to make the light output of the backlight module 120 match the display screen of the display panel 110.

Therefore, in the present embodiment, the first controller 3211 may also include a delay circuit DLC. The delay circuit DLC may be used to delay the update time points of the plurality of update periods DT1 to DT4 to improve the probability of matching the light output of the backlight module 120 with the display screen of the display panel 110.

Furthermore, after the first controller 3211 receives the pulse wave of the backlight horizontal synchronization signal HSYNC_BLU, the first controller 3211 generates an enabling signal EN when the wait time is equal to a default wait value VT of the delay circuit DLC, and the buffer BF is enabled using the enabling signal EN, so that the buffer BF transmits the received light emission driving data DA1 to DAm to the register 3213. Therefore, the enabling time point of the buffer BF is equal to the update time point. The converter 3214 receives the light emission driving data DA1 to DAm registered in the register 3213 and converts the light emission driving data DA1 to DAm into analog driving signals VA1 to VAm. The analog driving signals VA1 to VAm are respectively, for example, voltage signals or current signals. The converter 3214 may be implemented by a digital-to-analog conversion circuit.

In some embodiments, the register 3213 may be disposed in the converter 3214. The output terminal of the buffer BF is electrically connected to the converter 3214. In some embodiments, the register 3213 may be omitted. In some embodiments, the delay circuit DLC may be omitted, or the default wait value VT of the delay circuit DLC may be set to 0. Therefore, when the first controller 3211 receives the pulse wave (for example, the pulse wave Pl of the backlight horizontal synchronization signal HSYNC_BLU) of the backlight horizontal synchronization signal HSYNC_BLU, the enabling signal EN may be output without waiting. In addition, the timing controller 230 of FIG. 3A to FIG. 3C may perform the above operations of the timing controller 430.

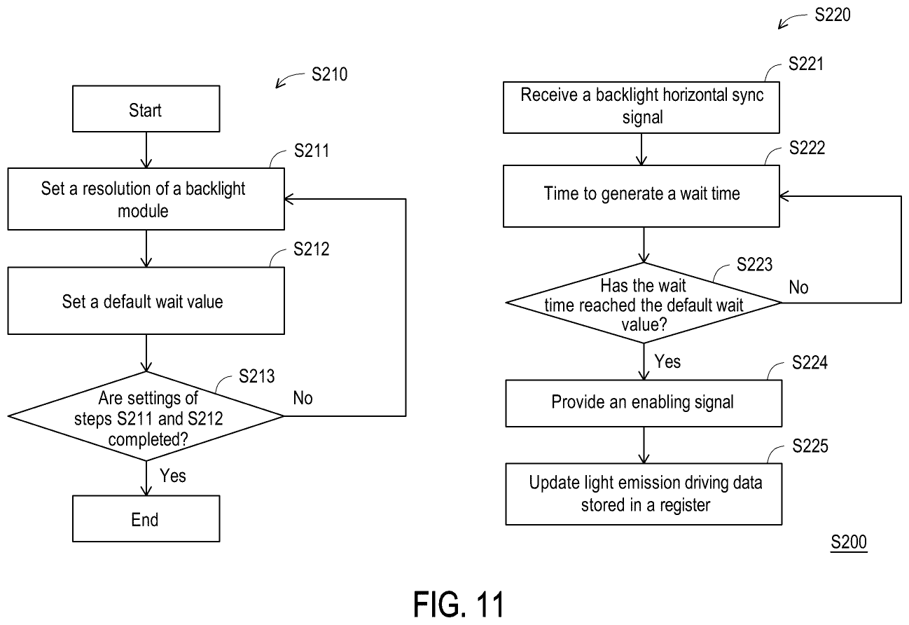

Please refer to FIG. 8, FIG. 10, and FIG. 11 at the same time. FIG. 11 is an operation flowchart shown according to FIG. 10. In the present embodiment, an operation process S200 includes a setting step S210 and an updating step S220. The setting step S210 includes steps S211 to S213. After the backlight driver 321 is started, the backlight driver 321 sets the resolution of the backlight module in step S211. In step S212, a backlight driver 421 sets the default wait value VT of the delay circuit DLC. In step S213, the backlight driver 321 confirms whether the operations of steps S211 and S212 are completed. When the operations of steps S211 and S212 are not completed, the backlight driver 321 returns to step S211 to re-execute the setting step S210. When the operations of steps S211 and S212 are completed, the setting step S210 is ended.

The update step S220 includes steps S221 to S225. In step S221, the first controller 3211 receives the backlight horizontal synchronization signal HSYNC_BLU. Next, the delay circuit DLC counts in step S222 to generate a wait time, and determines whether the wait time reaches the default wait value VT in step S223. When the wait time has not reached the default wait value VT, the delay circuit DLC continues to time in step S222. When the wait time reaches the default wait value VT, the delay circuit DLC notifies the first controller 3211 to provide the enabling signal EN in step S224. In step S225, the light emission driving data DA1 to DAm registered in the register 3213 are updated.

In addition, at least one of the backlight drivers 221_1 to 221_4 of FIG. 3A to FIG. 3C may perform the above operations of the backlight driver 321.

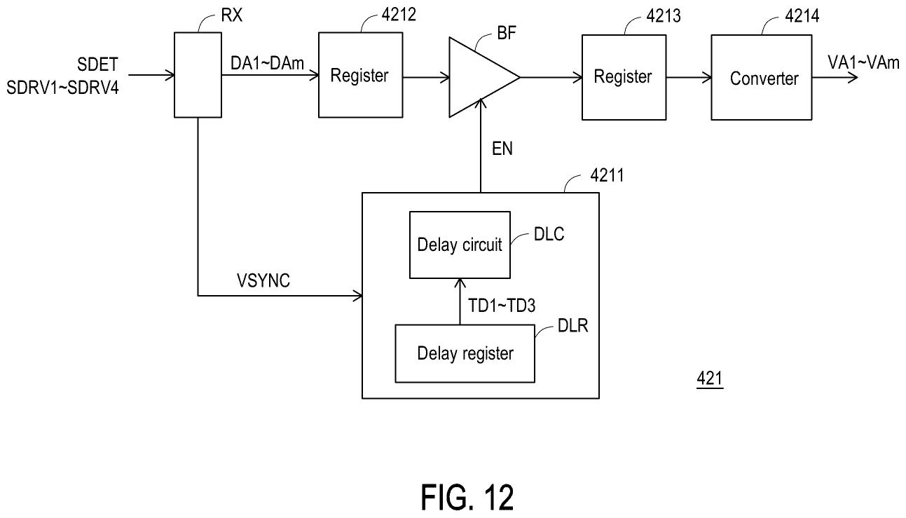

Please refer to FIG. 12. FIG. 12 is a schematic diagram of a backlight driver shown according to an embodiment of the disclosure. In the present embodiment, the backlight driver 421 includes the receiving interface RX, a first controller 4211, registers 4212 and 4213, the buffer BF, and a converter 4214. The receiving interface RX receives the determination signal SDET and the driving signals SDRV1 to SDRV4. The receiving interface RX provides the determination signal SDET to the first controller 4211, and provides the light emission driving data DA1 to DAm to the register 4212.

In the present embodiment, the determination signal SDET includes the vertical synchronization signal VSYNC. Therefore, the first controller 4211 receives the vertical synchronization signal VSYNC and determines the update time points of the update periods DT1 to DT4 according to the vertical synchronization signal VSYNC and a plurality of default delay periods TD1 to TD3.

The input terminal of the buffer BF is electrically connected to the register 4212. The output terminal of the buffer BF is electrically connected to the converter 4214. Furthermore, the output terminal of the buffer BF is electrically connected to the converter 4214 via the register 4213. The control terminal of the buffer BF is electrically connected to the first controller 4211.

After the first controller 4211 receives the vertical synchronization signal VSYNC, the first controller 4211 generates the enabling signal EN when the delay time (such as the timing value below) is equal to the default delay times TD1 to TD4 of the delay circuit DLC, and enables the buffer BF using the enabling signal EN, so that the buffer BF transmits the received light emission driving data DA1 to DAm to the register 4213. Therefore, the enabling time point of the buffer BF is equal to the update time point. The converter 4214 receives the light emission driving data DA1 to DAm registered in the register 4213 and converts the light emission driving data DA1 to DAm into the analog driving signals VA1 to VAm. The analog driving signals VA1 to VAm are respectively voltage signals or current signals. The converter 4214 may be implemented by a digital-to-analog conversion circuit.

In some embodiments, the register 4213 may be disposed in the converter 4214. The output terminal of the buffer BF is electrically connected to the converter 4214. In some embodiments, register 4213 may be omitted.

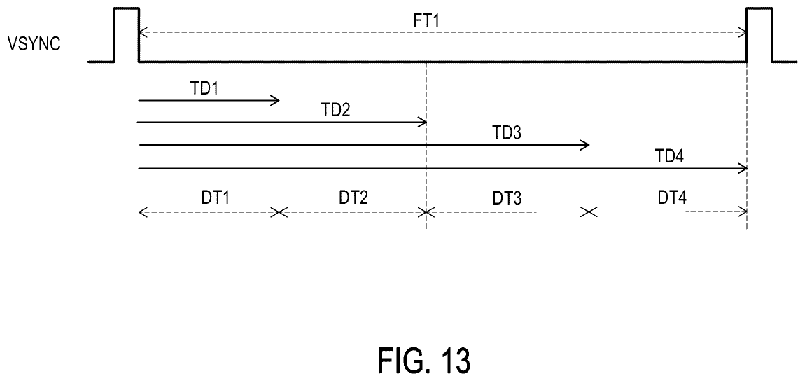

Please refer to FIG. 12 and FIG. 13 simultaneously. FIG. 13 is a signal timing diagram shown according to an embodiment of the disclosure. FIG. 13 shows a signal timing diagram of the vertical synchronization signal VSYNC. In the present embodiment, there are four update periods DT1 to DT4. When the first controller 4211 receives the vertical synchronization signal VSYNC, the update period DT1 is started, and the first controller 4211 starts timing to generate a timing value. When the timing value reaches the default delay time TD1, the update period DT1 is ended and the update period DT2 is started. The first controller 4211 continues timing. Therefore, the timing value continues to be accumulated. When the timing value reaches the default delay time TD2, the update period DT2 is ended and the update period DT3 is started. When the timing value reaches the default delay time TD3, the update period DT3 is ended and the update period DT4 is started. In the disclosure, the number of update periods is not limited thereto. For example, there are two or more update periods. In some embodiments, the time length of the frame period FT1 may be greater than or equal to 1 millisecond (ms) and less than or equal to 32 ms, and the time length of the delay time TD1 may be greater than or equal to 1 microsecond (μs) and less than or equal to 16 milliseconds, but the disclosure is not limited thereto. For example, the time length of the frame period FT1 may be any value or any value range such as 1 millisecond, 4 milliseconds, 8 milliseconds, 12 milliseconds, 16 milliseconds, 20 milliseconds, 24 milliseconds, 28 milliseconds, 32 milliseconds, etc. The time length of the delay time TD1 may be any value or any value range such as 1 microsecond, 100 microseconds, 500 microseconds, 1 millisecond, 2 milliseconds, 4 milliseconds, 8 milliseconds, 12 milliseconds, 16 milliseconds, etc. In some embodiments, the time length of the delay times TD2 to TD4 may be an integer multiple of the delay time TD1. In some embodiments, the time length of the delay time TD4 is substantially equal to the time length of the frame period FT1.

Further, the first controller 4211 includes the delay circuit DLC and a delay register DLR. The delay register DLR registers the default delay times TD1 to TD4. The delay circuit DLC is electrically connected to the delay register DLR. The delay circuit DLC receives the default delay times TD1 to TD4. When the first controller 4211 receives the vertical synchronization signal VSYNC, the update period DT1 is started, and the delay circuit DLC starts timing to generate a timing value. When the timing value reaches the default delay time TD1, the update period DT1 is ended and the update period DT2 is started. The delay circuit DLC continues timing. When the timing value reaches the default delay time TD2, the update period DT2 is ended and the update period DT3 is started. When the timing value reaches the default delay time TD3, the update period DT3 is ended and the update period DT4 is started. When the timing value reaches the default delay time TD4, the update period DT4 is ended.

In the present embodiment, the operations in the update periods DT1 to DT4 are clearly explained in the first example and the second example in the embodiments of FIG. 1 and FIG. 4 and are therefore not repeated here.

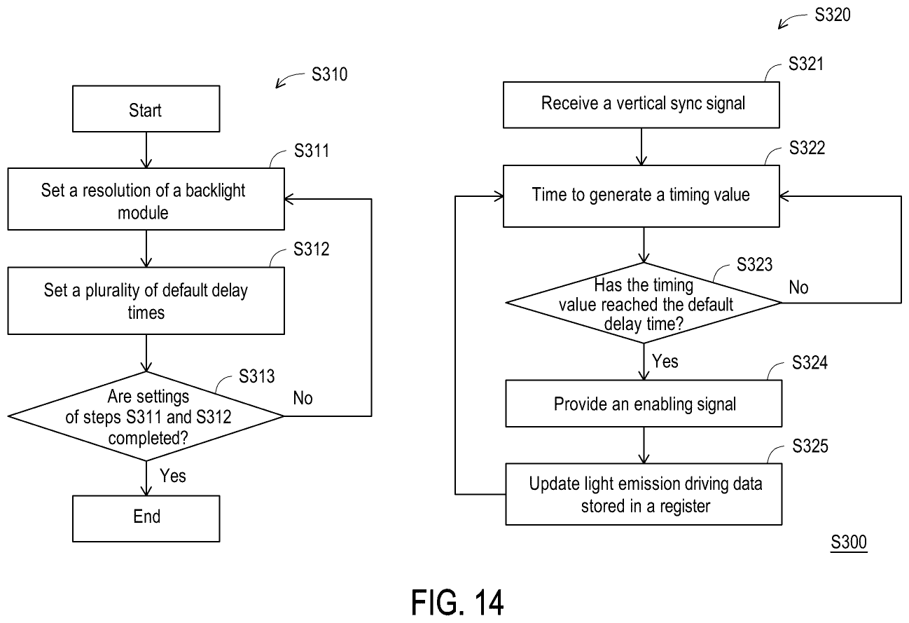

Please refer to FIG. 12, FIG. 13, and FIG. 14 at the same time. FIG. 14 is an operation flowchart shown according to FIG. 12. In the present embodiment, an operation process S300 includes a setting step S310 and an updating step S320. The setting step S310 includes steps S311 to S313. After the backlight driver 421 is started, the backlight driver 421 sets the resolution of the backlight module in step S311. In step S312, the backlight driver 421 sets the default delay times TD1 to TD4 and stores the default delay times TD1 to TD4 into the delay register DLR. In step S313, the backlight driver 421 confirms whether the settings of steps S311 and S312 are completed. When the operations of steps S311 and S312 are not completed, the backlight driver 421 returns to step S311 to re-execute the setting step S310. When the settings of steps S311 and S312 are completed, the setting step S310 is ended.

The update step S320 includes steps S321 to S325. In step S321, the first controller 4211 receives the vertical synchronization signal VSYNC. The update period DT1 is started. Next, the delay circuit DLC starts timing in step S322 to generate a timing value, and receives the default delay times TD1 to TD4 registered in the delay register DLR, and in step S323, determines whether the timing value reaches the default delay times TD1 to TD4. When the timing value has not reached the default delay time TD1, the delay circuit DLC continues timing in step S322. When the timing value reaches the default delay time TD1, the update period DT2 is started. The delay circuit DLC notifies the first controller 4211 to provide the enabling signal EN in step S324. In step S325, the light emission driving data DA1 to DAm registered in the register 4213 are updated in the update period DT2.

Next, the delay circuit DLC continues timing in step S322. When the timing value reaches the default delay time TD2, the update period DT3 is started. The delay circuit DLC notifies the first controller 4211 again to provide the enabling signal EN in step S324. In step S325, the light emission driving data DA1 to DAm registered in the register 4213 are updated in the update period DT3.

Next, the delay circuit DLC continues timing in step S322. When the timing value reaches the default delay time TD3, the update period DT4 is started. The delay circuit DLC notifies the first controller 4211 again to provide the enabling signal EN in step S324. In step S325, the light emission driving data DA1 to DAm registered in the register 4213 are updated in the update period DT4. In addition, at least one of the backlight drivers 221_1 to 221_4 of FIG. 3A to FIG. 3C may perform the above operations of the backlight driver 421.

Based on the above, in the backlight module, the register provides the driving signal to the plurality of light-emitting elements of the corresponding region during the plurality of update periods in the frame period. The register does not provide all driving signals of a single frame to the plurality of regions. Therefore, the data update speed of the backlight module of the disclosure may be improved. Furthermore, it should be noted that the display panel is, for example, a liquid-crystal display panel. The display panel has the display delay of the liquid-crystal element. Therefore, the update time point is delayed so that the light output of the backlight module may match the display screen of the display panel, thereby reducing the probability that the light output screen of the backlight module is faster than the display screen of the display panel.

Lastly, it should be noted that the above embodiments are used to describe the technical solution of the disclosure instead of limiting it. Although the disclosure has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the disclosure.

What is claimed is:

1. A display device, the device comprising:
a display panel;
a backlight module having a plurality of regions and configured to provide a light to the display panel, wherein each of the plurality of regions comprises a plurality of light-emitting elements, and the backlight module comprises:
a backlight driver electrically connected to the plurality of light-emitting elements and comprising a first controller and a register; and
a timing controller electrically connected to the display panel and the backlight module and configured to provide a determination signal to the first controller and provide a driving signal to the register,
wherein there are a plurality of update periods in a frame period, the first controller receives the determination signal and determines an update time point of each of the plurality of update periods at least according to the determination signal, and the register stores the driving signal, and
wherein during each of the plurality of update periods, the register provides the driving signal to the plurality of light-emitting elements of a corresponding region.

2. The display device of claim 1, wherein the backlight driver further comprises:
a converter configured to convert light emission driving data of the driving signal into an analog driving signal; and
a buffer, wherein an input terminal of the buffer is electrically connected to the register, an output terminal of the buffer is electrically connected to the converter, and a control terminal of the buffer is electrically connected to the first controller.

3. The display device of claim 2, wherein the first controller outputs an enabling signal and enables the buffer using the enabling signal, so that the buffer transmits the received light emission driving data of the driving signal to the converter.

4. The display device of claim 3, wherein the first controller comprises:
a delay register configured to register a plurality of default delay times; and
a delay circuit electrically connected to the delay register and configured to receive the plurality of default delay times and perform timing to generate a timing value.

5. The display device of claim 4, wherein:
when the backlight driver is started, the backlight driver sets a resolution of the backlight module and sets a default wait value of the delay circuit.

6. The display device of claim 5, wherein:
the determination signal comprises a backlight horizontal synchronization signal,
when the backlight horizontal synchronization signal is received, the delay circuit performs timing to generate a wait time, and
when the wait time reaches the default wait value, the delay circuit notifies the first controller to provide the enabling signal.

7. The display device of claim 1, wherein:
the determination signal comprises a backlight horizontal synchronization signal, and
the first controller determines an update time point of each of the plurality of update periods according to the backlight horizontal synchronization signal.

8. The display device of claim 1, wherein:
the determination signal comprises a vertical synchronization signal, and
the first controller determines an update time point of each of the plurality of update periods according to the vertical synchronization signal and a plurality of default delay times.

9. The display device of claim 8, wherein the first controller comprises a delay register for storing the plurality of default delay times.

10. The display device of claim 1, wherein:
the determination signal comprises a vertical synchronization signal and a horizontal synchronization signal,
when the first controller receives the vertical synchronization signal, a first update period among the plurality of update periods is started, and the first controller starts timing to generate a timing value.

11. The display device of claim 10, wherein when the timing value reaches a first default delay time among a plurality of default delay times, the first update period is ended, a second update period among the plurality of update periods is started, and the first controller continues timing.

12. The display device of claim 11, wherein when the timing value reaches a second default delay time among the plurality of default delay times, the second update period is ended, a third update period among the plurality of update periods is started, and the first controller continues timing.

13. The display device of claim 1, wherein the timing controller comprises:
a computing circuit configured to receive an image signal and generate a display driving signal and light emission driving data for driving the display panel according to the image signal; and
a second controller electrically connected to the computing circuit and configured to generate the determination signal according to the horizontal synchronization signal and the vertical synchronization signal.

14. The display device of claim 13, wherein:
the second controller provides a plurality of address signals and a plurality of command signals according to the horizontal synchronization signal and the vertical synchronization signal.

15. The display device of claim 14, wherein the timing controller further comprises:
a transmission circuit electrically connected to the computing circuit and the second controller and configured to encode a first command signal among the plurality of command signals, a first address signal among the plurality of address signals, and light emission driving data corresponding to an address of the first address signal as the driving signal.

16. The display device of claim 13, wherein:
the determination signal comprises a backlight horizontal synchronization signal,
the determination signal causes the second controller to transmit the backlight horizontal synchronization signal to the backlight driver.

17. The display device of claim 1, wherein:
the determination signal comprises a vertical synchronization signal and a horizontal synchronization signal, and
the first controller determines an update time point of each of the plurality of update periods according to the vertical synchronization signal and the horizontal synchronization signal.

18. The display device of claim 1, wherein the driving signal comprises a command signal, an address signal, and light emission driving data.

19. The display device of claim 1, wherein a plurality of light-emitting components in each of the plurality of regions are arranged along a first direction, the plurality of regions are arranged along a second direction, and the first direction is perpendicular to the second direction.

20. The display device of claim 1, wherein a time length of the frame period is greater than or equal to 1 millisecond and less than or equal to 32 milliseconds, and a time length of each of the plurality of update periods is greater than or equal to 1 microsecond and less than or equal to 16 milliseconds.
